(19) United States
(12) Patent Application Publication
(10) Pub. No.: US 2022/0089986 A1
(43) Pub. Date: Mar. 24, 2022

(54) Beverage Composition And Methods For Preparing Beverages

(71) Applicant: Bottomless Beverages Company, Moraga, CA (US)

(72) Inventors: Marc Travers, Berkeley, CA (US); Sterling Albert, III, Concord, CA (US)

(21) Appl. No.: 17/482,400

(22) Filed: Sep. 22, 2021

Related U.S. Application Data
(60) Provisional application No. 63/081,602, filed on Sep. 22, 2020.

(51) Int. Cl. C12G 3/06; B65D 77/06; B67D 1/00

(52) U.S. Cl. CPC C12G 3/06; B67D 1/0086; B67D 1/0034; B65D 77/06

(57) ABSTRACT

Beverage composition and methods for preparing beverages are disclosed. In one embodiment, an alcohol-based syrup is provided. The alcohol-based syrup is combinable with water to form a beverage that replicates an alcoholic cocktail. The syrup is dispensed in selected proportions with water through a typical soda gun or soda machine to achieve consistent drink quality. A large quantity of syrup can be easily dispensed to produce a significant number of consistent and high quality alcoholic beverages. Alcoholic beverages are dispensed in a speedy fashion allowing restaurants and other beverage-serving establishments to provide quality beverages to many customers in a quick and consistent fashion. The syrup is easily stored and transported to ensure longer shelf life than traditional cocktail ingredients. In other embodiments, the alcohol-based syrups are storable in portable pouches allowing consumers to conveniently and safely transport the alcohol-based syrups and combine them with water to form high quality beverages.

### CROSS-REFERENCE TO RELATED APPLICATIONS

This application claims the benefit under 35 U.S.C. § 119 from U.S. Provisional Patent Application Ser. No. 63/081,602, entitled “Bottomless Beverage System,” filed on Sep. 22, 2020, the subject matter of which is incorporated herein by reference.

### TECHNICAL FIELD

The present disclosure relates generally to beverages, and more particularly, to beverage composition and methods for preparing beverages.

### BACKGROUND INFORMATION

Beverages play an important role in people's lives by providing sustenance and enjoyment. Common types of beverages include drinking water, milk, juice and soft drinks, and alcoholic beverages. Over time, beverages have been crafted and developed tailored to the tastes, nutritional requirements and preferences of a given society resulting in the production of a variety of different beverages.

### SUMMARY

In various exemplary embodiments, beverage compositions and methods for preparing beverages are disclosed. The embodiments further provide methods and devices for preparing beverages. The method and device are further configured to provide highly drinkable and stable alcoholic beverages. The method and device are configured to provide an improved packaging protocol. The method and device are further configured to provide a beverage that has extended shelf life and avoids deterioration due to long or rigorous storage.

In one embodiment, an alcohol-based syrup is provided that contains high proof alcoholic spirits, natural juices and other flavorings, that is mixed in a soda machine at a ratio ranging from 2-to-1 to 30-to-1 with water to become an alcoholic cocktail that can be consistently and repeatedly reproduced. Additionally, any desired cocktail can be created by changing the formula of the syrup and/or other ingredients.

In another embodiment, the method for preparing a beverage involves concentrating alcohol within a syrup and then diluting the syrup with water to form the beverage. In one embodiment, the syrup is packaged in a bag-in-box container. In another embodiment, the syrup is provided as a constant concentrated alcohol syrup in a pouch that can be served with water. In one embodiment, the concentrated syrup is provided in a 5:1 ratio with water to form a drink provided to a consumer.

In another embodiment, a syrup formed to produce a Mimosa cocktail comprises 40 to 160 mls orange juice concentrate, 60 to 240 mls high proof grape distilled spirits, 3 to 12 tsp flavor and ½ tsp to 2 tsp of citric acid.

In various embodiments, the post-mix alcohol content is from 1% to 40%. A typical mimosa comprises 50% of champagne brut, 12% of alcohol at 3.3 pH, and 50% of orange juice with 20 g of sugar. In one embodiment, the syrup produces an 8 oz. serving having 3.5 pH. In another embodiment, the syrup comprises soda water, high proof alcohol, sparkling base and chardonnay base. In yet another embodiment, the syrup produces 6 oz. of mimosa having 6% of alcohol and 7.5 grams of sugar. In various embodiments, post-mix alcohol content is from 1% to 40%. The initial alcohol content of Mimosa may be, in one embodiment, about 8% alcohol.

In yet another embodiment, the syrup composition comprises sparkling base, amoretti champagne, grape concentrate, orange juice concentrate and citric acid. In yet another embodiment, the syrup comprises 6% of alcohol and 1.25 grams sugar per ounce of concentrate. In yet another embodiment, an eight ounce serving of the beverage has a 3.5 pH.

In yet another embodiment, the syrup comprises high proof alcohol, flavor base, and natural flavor extract. In yet another, the syrup comprises high proof alcohol, flavor base, 100% of organic orange juice concentrate and citric acid in a proprietary blending ratio.

In various embodiments, post-mix alcohol content is from 1% to 40%. In some embodiments, the broader-base ratio of syrup mix to water is between about 2:1 to about 30:1.

In another embodiment, an alcohol-based syrup is provided, which when combined with water in a selected ratio, forms an alcoholic beverage. The alcohol-based syrup comprises a liquid and a selected amount of alcohol to produce a selected alcohol concentration in the syrup. When the syrup is combined with the water in a selected ratio to form the beverage, the beverage will have a beverage alcohol content that matches an alcohol content of a selected alcoholic cocktail.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 shows a diagram that illustrates a fixed ratio dispenser that dispenses an alcoholic beverage in accordance with various embodiments.

FIG. 2 shows an exemplary beverage dispensing system according to one embodiment.

FIG. 3 shows exemplary modules involved in carbonation, according to an embodiment.

FIG. 4 shows an exemplary beverage composition that results from operation of the embodiments.

FIG. 5 shows an exemplary ice-cooled system according to an embodiment.

FIG. 6 shows an exemplary bag-in-box container for use in embodiments.

FIG. 7 shows an exemplary soda gun for use in embodiments.

FIG. 8 shows an exemplary apparatus for producing a syrup in accordance with the embodiments.

FIG. 9 shows a method for producing a syrup in accordance with the embodiments.

FIG. 10 shows a method for operating the apparatus of FIG. 8 to generate a syrup.

FIG. 11 shows an exemplary pouch that can be used as a package for syrup.

FIG. 12 shows a method for packaging a syrup in a pouch and distributing the pouch to retailers and consumers.

### DETAILED DESCRIPTION

Reference will now be made in detail to some embodiments, examples of which are illustrated in the accompanying drawings.

The embodiments disclose a beverage composition that has extended shelf life, avoids deterioration due to long or rigorous storage, and highly drinkable flavor. The embodiments further disclose methods and devices for preparing beverages.

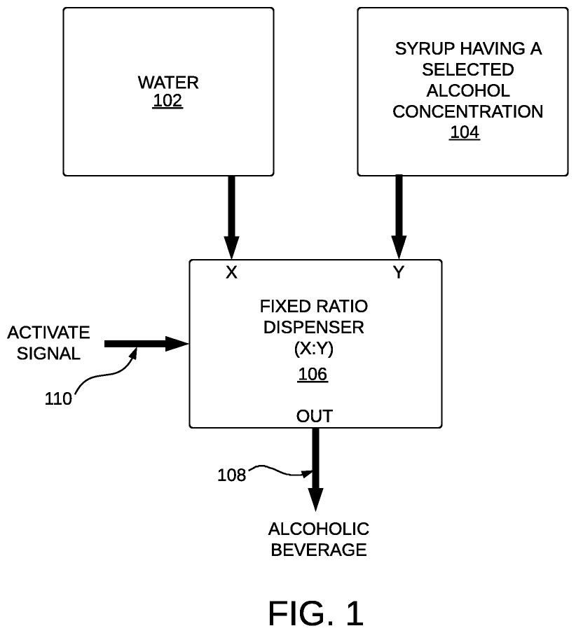

FIG. 1 shows a diagram 100 that illustrates a fixed ratio dispenser 106 that dispenses an alcoholic beverage 108 in accordance with the embodiments. The fixed ratio dispenser 106 comprises a first input port (X) and a second input port (Y) to receive first and second liquids, respectively. In an embodiment, the first liquid received at input port X is water 102 that comprises virtually any type of water, such as tap water, spring water, filtered water, carbonated water, or any other type of water. In an embodiment, the second liquid received at the input port Y is a syrup 104 having a selected alcohol concentration. In an embodiment, the alcohol concentration is selected so that when the syrup 104 is dispensed by the dispenser 106 the resulting beverage 108 will have a desired alcohol content.

During operation, the dispenser 106 receives an activate signal 110 that causes the dispenser 106 to dispense the liquids received at ports X and Y from an output port (OUT). For example, the activate signal 110 is generated in response to a button or lever actuation. Once the dispenser 106 is activated, the water 102 received at port X and the syrup 104 received at port Y are dispensed from the output port OUT. The received water 102 and syrup 104 are dispensed at a fixed ratio of (X:Y). In an embodiment, the ratio is 5:1 so that 5 units of water are dispensed for every 1 unit of syrup. Depending on the beverage to be dispensed, the fixed ratio dispenser can be set to dispense at any ratio within a range of 2:1 to 20:1.

In an embodiment, the dispenser 106 comprises a soda gun or bar gun that is used by bars and restaurants to serve various types of carbonated and non-carbonated drinks. A soda gun has the ability to serve any beverage that is some combination of syrup, water, and carbon dioxide. This includes soft drinks, iced tea, carbonated water, and plain water. When served from a soda gun, these are often known as fountain drinks.

In an embodiment, a post-mix soda gun combines concentrated syrup from a bag-in-box container and mixes it with filtered tap water, either carbonated or non-carbonated, at the point of dispensing. For a post-mix soda gun to function it is connected to a bag-in-box system, including pumps, a chiller, water filtration system and a carbonator. A post-mix soda gun is able to supply any beverage product that can be dispensed in bag-in-box form. In one embodiment, the syrup 104 is packaged in a bag-in-box container for use with a soda gun to allow alcoholic drinks to be dispensed by the dispenser 106.

In one embodiment, a method for preparing a beverage comprises an operation of formulating the syrup 104 having a selected alcohol concentration. The method also includes dispensing water 102 and the syrup 104 with a fixed ratio to form the beverage. In one embodiment, the syrup 104 is packaged within a bag-in-box container. In another embodiment, the syrup is provided as a concentrated alcohol syrup in a bag that can be split up into portions for serving. In one embodiment, water and the concentrated syrup are dispensed in a 4:1 ratio to form a beverage for a consumer. In some embodiments, the dispenser 106 is set to have a dispensing ratio of water 102 to syrup 104 between about 2:1 to about 30:1.

In one embodiment, the syrup 104 comprises 40 to 160 mls of orange juice concentrate, 60 to 240 mls of high proof grape distilled spirits, 3 to 12 tsp of flavorings and ½ tsp to 2 tsp of citric acid to form a Mimosa beverage when combined with carbonated water.

In one embodiment, the syrup 104 comprises 50% of champagne brut extract, 12% of alcohol at 3.3 pH, 50% of orange juice concentrate, and 20 g of sugar. In various embodiments, post-mix beverage 108 has an alcohol content from 1% to 40%.

In yet another embodiment, the syrup 104 has a composition comprising a sparkling base, amoretti champagne, grape concentrate, orange juice concentrate and citric acid. In yet another embodiment, the dispensed beverage 108 has a composition comprising 6% of alcohol and 1.25 grams of sugar per ounce of concentrate. In yet another embodiment, eight ounces of the dispensed beverage has 3.5 pH.

In yet another embodiment, the syrup 104 comprises high proof alcohol, flavor base, and natural flavor extract. In yet another, the syrup 104 comprises high proof alcohol, flavor base, 100% of organic orange juice concentrate and citric acid in a proprietary blending ratio.

In one embodiment, the syrup 104 is packaged in a multi-layer Mylar and polyvinylpolypyrrolidone (pvpp) bag. In another embodiment, the syrup 104 is delivered via a standard soda machine. In yet another embodiment, the syrup 104 is delivered via a bar gun for carbonation. In one embodiment, a syrup having high proof alcohol in suspension by using a blending technique of emulsifying the syrup. According to the embodiments, the syrup 104 comprises alcohol that is slowly blended into a flavor base, orange juice concentrate, flavor extract, and citric acid used for pH adjustment and as a preservative. Further, the stability and shelf life of the syrup 104 is determined through stabilization testing. Further, the syrup 104 does not require refrigeration. In an embodiment, the syrup is packaged via a Cartobol easy start bag filler.

In one embodiment, the syrup comprises alcohols including, but not limited to, malt beverage, grain spirit, wine spirit, fermented beverage, fortified wine, grain alcohol, distilled, fermented spirit or combination thereof. In another embodiment, the syrup is used to produce a variety of alcoholic cocktails including, but not limited to, margarita, mimosa, Bellini, strawberry daiquiri, Cuba libre, agave sunrise, Kentucky sour, Cali mule, mango mojito, and flavored hard seltzer.

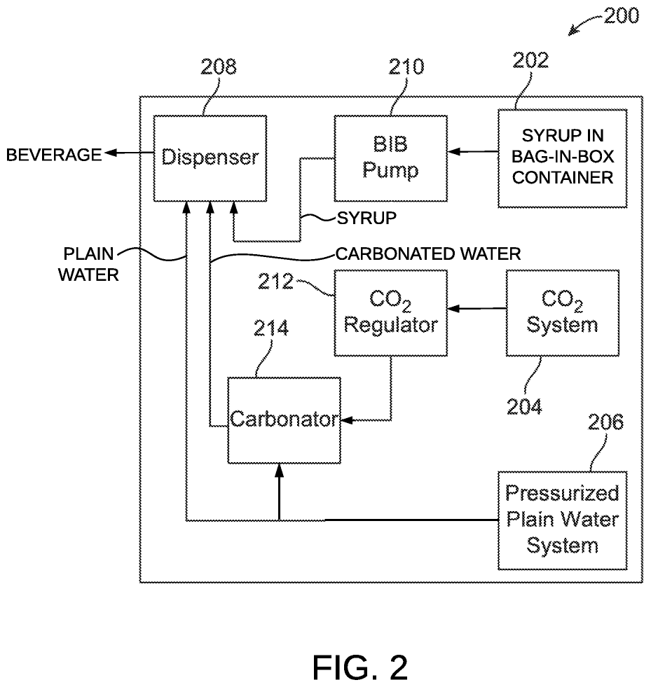

FIG. 2 shows an exemplary beverage dispensing system 200 according to an embodiment. The system 200 ensures the beverage dispensed meets a standard specification. The system 200 comprises a bag-in-box container 202 filled with syrup, a CO2 system 204, and a pressurized plain water system 206. The system 200 includes a dispenser 208 and bag-in-box (BIB) pump 210. The CO₂ system 204 is coupled to a CO₂ regulator 212. In an embodiment, the dispenser 106 shown in FIG. 1 is suitable for use as the dispenser 208 shown in FIG. 2.

The pressurized plain water system 206 is coupled to a carbonator 214 so that carbonated water can be produced. In one embodiment, the dispensing system 200 produces high quality and consistent alcoholic drinks in a simple 4-step process. At one step, the syrup is transported from the bag-in-box to the dispenser 208 using a BIB Pump 210. The BIB pump 210 maintains constant pressure through the syrup line to the dispenser 208, where the syrup is chilled on a cold-plate on the flow path to the dispensing valve. At another step, water and carbon dioxide (CO₂) gas are mixed in a carbonator 214 to produce carbonated water, or soda water. At yet another step, the carbonated water is chilled on the cold-plate on the flow path to the dispensing valve. The carbonation level is enhanced as the soda water is chilled on the cold plate.

At yet another step, the dispensing valve is set to mix carbonated water and syrup at the correct dispensing ratio, producing a perfectly mixed alcoholic drink with a temperature less than 40 degrees Fahrenheit (F). Further, the end beverage product has a consistent taste, carbonation, temperature less than 40 degrees F.

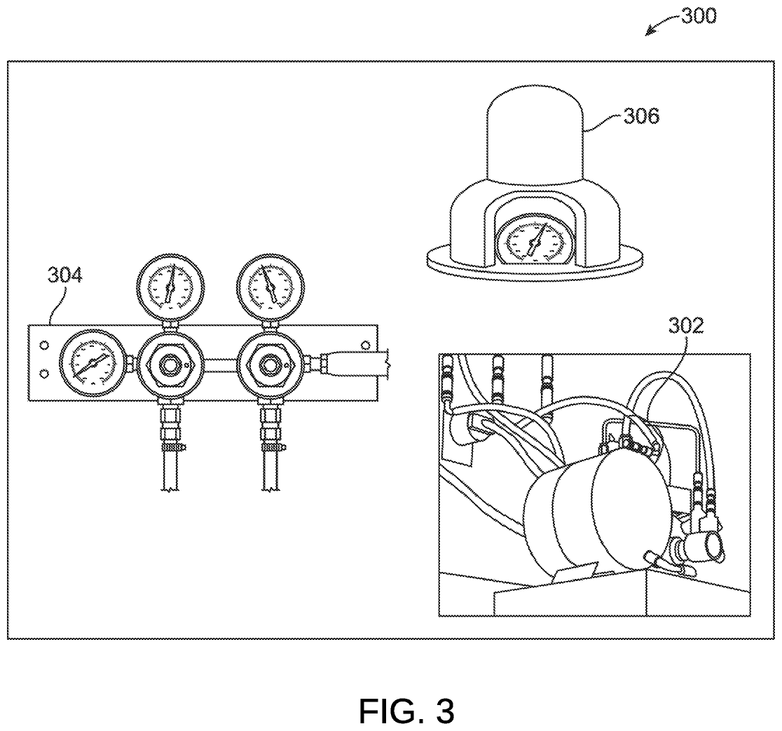

FIG. 3 shows exemplary modules 300 involved in carbonation, according to an embodiment. Carbonation is an important element of serving a quality drink. Proper carbonation comes from the right amount of carbon dioxide (CO₂) gas being mixed with water in soft drink systems. Before carbonation processes, the tank, pressure and the carbonator 302 need to be checked. In one embodiment, the tanks could be checked by observing 0 to 3000 psi gauge. In one embodiment, the gauge has a red pie shaped section indicating a tank change. In another embodiment, the tank has a red bar area. In another embodiment, the tanks do not have markings and need to be changed when pressure is under 500 psi. In yet another embodiment, the contents gauge for a 20-50 lb tank should be at 500 psi or above. In yet another embodiment, the contents gauge for a bulk CO₂ tank should be at least ¼ full.

The hi pressure gauge 304 (red 0-160) controls the flow of CO₂ to the carbonator. This gauge needs to be set at 105 psi for remote carbonators and 70 psi for fountain dispensers using cold carbonation. The low-pressure gauge (gray or gold 0-100) controls the flow of CO₂ to the Bag-in-Box pumps and should be set at 65 psi. Further, the level of CO₂ 306 is also checked. Further, the plain water and CO₂ are mixed to form carbonated water at the carbonator. If the carbonator fails to operate, the drinks or beverage would be flat and water would not be dispensed from the soda machine.

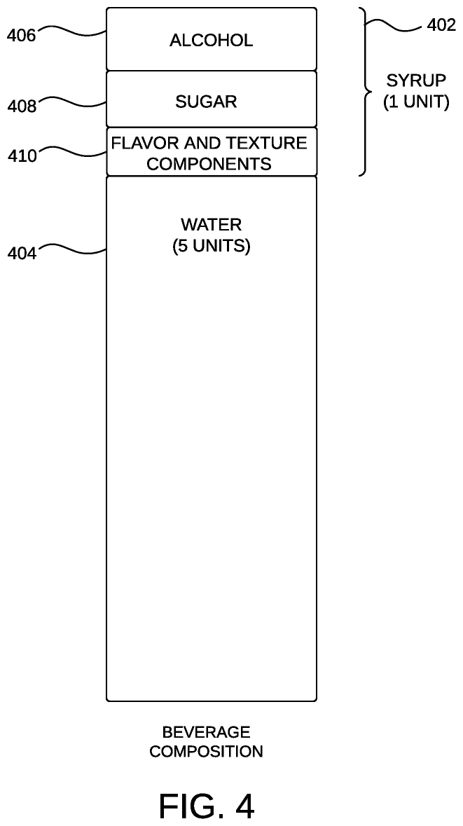

FIG. 4 shows an exemplary embodiment of a beverage composition that results from operation of embodiments. The beverage composition comprises a syrup 402 and water 404. In an embodiment, the syrup 402 comprises alcohol 406, sugar 408, and flavor and texture components 410. The syrup 402 is dispensed with the water 404 in selected proportions. For example, in a 5:1 ratio, 5 units of water are dispensed for 1 unit of syrup.

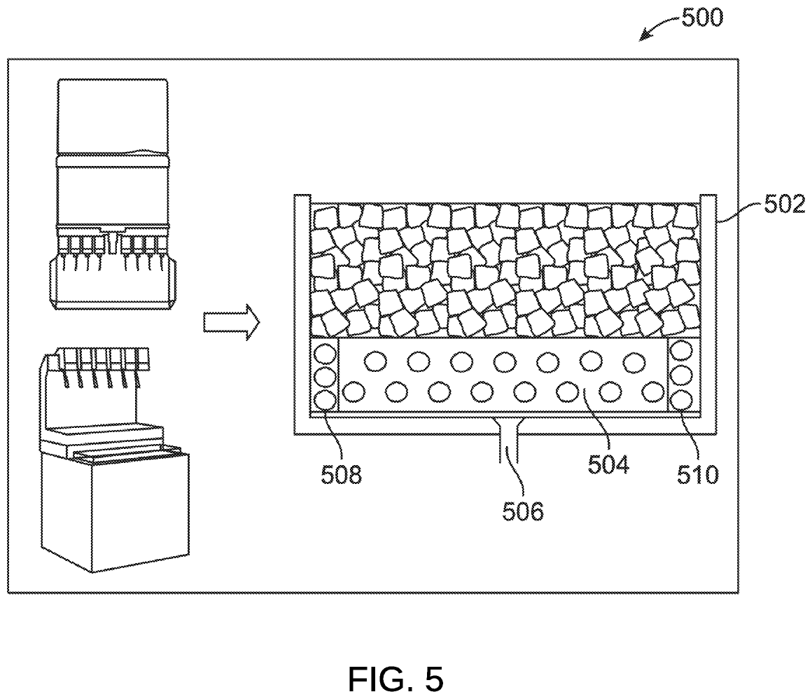

FIG. 5 shows an exemplary ice-cooled system 500 according to an embodiment. In one embodiment, ice is utilized to cool beverages. The ice-cooled refrigeration relies on a cold plate 504 which is located at the bottom of the ice bin 502. The cold plate 504 is made of stainless-steel coils that are cast into an aluminum plate. The syrup and plain/carbonated water are cooled by the ice on the cold plate 504 as they pass through the coils. The ice must be in contact with the cold plate 504 to chill the drinks properly. Further, the flaked ice and bagged ice are not recommended for use with ice cooled systems 500. In case of utilizing bagged ice, the ice needs to be made into pieces before filling ice bin 502.

The cold plate 504 works efficiently when covered with ice. Generally, ⅓ of ice bins are filled with ice for proper cooling. Further, cold plate 504 works poorly if water from me from melting ice does not drain away. Hence, proper working of ice bin drain 506 needs to be ensured. Furthermore, the ice in the ice bin needs to be stirred frequently to break up gaps for ice bridging.

An inlet 508 and an outlet 510 is provided for circulating and cooling the beverage. For self-serve dispensers, the equipment utilizes an agitator that runs every few minutes for ice bridging. Ice bridging results when the ice directly in contact with the cold plate 504 melts and there is a gap of air between the bottom of the ice and the cold plate 504. This will result in warm drinks and ensure ice is in contact with the cold plate 504 at all times.

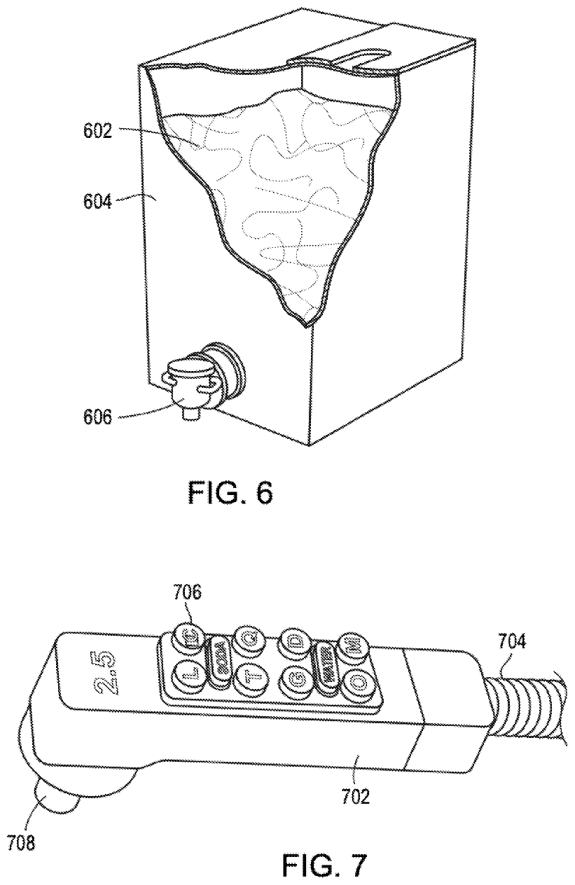

FIG. 6 shows an exemplary embodiment of a bag-in-box container for use in embodiments. The container comprises an internal bag 602 that is filled with syrup, such as syrup 402, and a box 604 that houses the bag 602 and provides for transportation and storage. A valve 606 is also provided to allow syrup to be pumped into the bag 602 during manufacture, and then pumped out from the bag 602 during dispensing.

FIG. 7 shows an exemplary embodiment of a soda gun for use in embodiments. The soda gun comprises a handle 702 coupled to a feed tube assembly 704. The feed tube assembly 704 comprises multiple feed lines that carry water and syrup to the handle for dispensing. The gun also comprises one or more buttons 706 that are pressed by a user to activate dispensing. For example, when a button is depressed, syrup in one of the feed lines is combined with water in another feed line and the combination forms a beverage that is dispensed from a nozzle 708. For example the beverage can be a Mimosa or other alcoholic beverage.

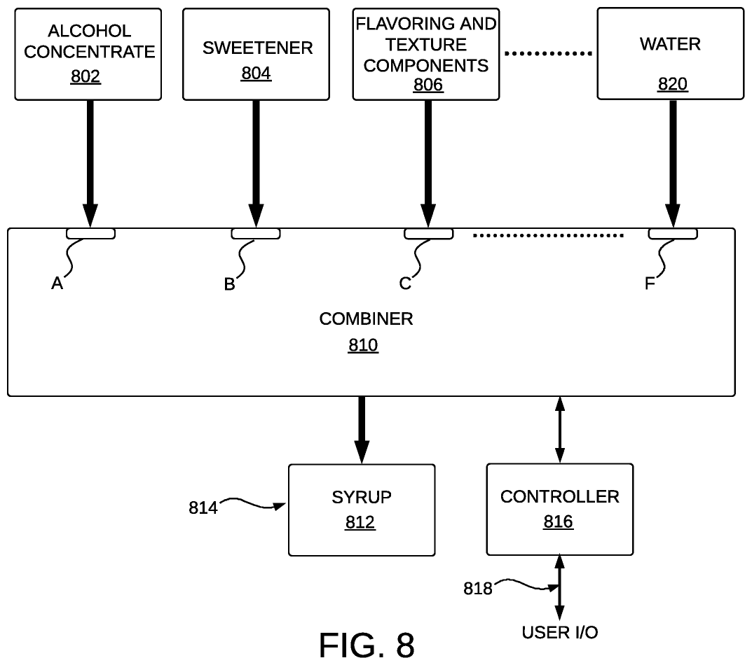

FIG. 8 shows an exemplary embodiment of an apparatus for producing a syrup in accordance with the embodiments. The apparatus comprises a series of containers or “hoppers” in which raw ingredients are loaded for the particular syrup to be produced. For example, the first container 802 contains any suitable alcohol concentrate, and a second container 804 contains sweetener, such as sugar, fruit juice, a sweetener concentrate, or sugar substitute. The apparatus also comprises a third container 806 that contains flavoring and texture components, such as herb extracts. Any number of containers or hoppers can be used to hold the ingredients for the syrup. A last container 820 contains water that can be used to dilute the syrup.

A combiner 810 comprises controllable valves (A-F) that can be used to control the amount of ingredients delivered to the combiner. The combiner 810 mixes and combines the received ingredients together using any suitable process to mix, emulsify, and/or combine the ingredients to form a selected amount of syrup.

A controller 816 is provided that comprises a computer, processor, microcontroller, state machine, programmable logic, memory, input/output interfaces, display, keyboard, mouse device, and/or any other component or peripheral. The controller 816 operates to control the valves (A-F) so that the ingredients can be controllably delivered to the combiner in any order, at any time, and over any time interval. The amount of each ingredient is determined by the beverage that is to be produced when the syrup is combined with water in selected proportions. A user interacts with the controller using an input/output communication path 818.

During operation, the user enters into the controller 816 a drink for which a syrup is to be produced. The user also enters a dispensing ratio and an amount of syrup to be produced. The controller 816 determines the ingredients to be used and their corresponding amounts to obtain a syrup to be used to produce the selected drink at the selected dispensing ratio. The controller 816 displays or indicates to the user which ingredients are to be placed in each hopper or container.

Once the ingredients are loaded, the user enters a start command to the controller 816. The controller 816 determines which of the valves are to be enabled to dispense the ingredients into the combiner 810. The ingredients are entered into the combiner in any order, at any time, and over any time interval under the control of the controller 816. For example, the controller 816 begins by controlling valve A to enter a select amount of alcohol concentrate into the combiner. The controller then controls valve B to enter a select amount of sweetener into the combiner. The controller starts the combining/mixing process and controls the other valves to add additional ingredients to the combiner as needed. The controller controls the combiner to combine/mix the ingredients for a selected time duration to produce a syrup having the desired content and consistency.

The resulting syrup 812 is fed into a container 814, which can be a bag-in-box container or a plastic pouch. In one embodiment, the syrup 812 is fed into a plastic pouch that a user can open to dispense the syrup directly into a predetermined amount of water. For example, the pouches are filled with the same syrup and sizes vary from 75 ml, 100 ml, 155 ml, 225 ml, and 375 ml. Water bottle style containers may also be used in sizes from 500 ml, 1 liter, 1.5 liter, and 1 gallon or virtually any other type of style of container can be used. Thus, no special equipment is needed for a user to dispense and mix the syrup with water to obtain the desired drink. The amount of syrup that is produced can be fed into a corresponding number of containers. For example, three liters of syrup can be fed into or packaged into two 1.5 liter bag-in-box containers.

The controller 816 can operate the combiner based on drink selection or direct input of ingredients. For example, in one embodiment, the user can directly input which ingredients to use to make the syrup.

In an embodiment, the controller 816 knows the recipes for a variety of drinks so that when a user selects a drink, the controller can retrieve the stored recipe of ingredients and control the combiner to produce the corresponding amount of syrup for that drink. The following is a list of ingredients to produce 1.5 liters of syrup to be dispensed at 5:1 (water:syrup) for several common drinks. The list is exemplary and not exhaustive and any number of additional drink recipes may be entered into the controller 816 for selection by a user.

Mimosa
740 mL of 92% alcohol concentrate
742 mL of water
3 mL of orange concentrate
5 mL of tangerine concentrate

Hard Seltzer
740 mL of 92% alcohol concentrate
742 mL of water
4 mL of blackberry concentrate
2 mL of raspberry concentrate
2 mL of blueberry concentrate

Margarita
740 mL of 92% alcohol concentrate
680 mL of water
20 mL of tequila extract
5 mL of lime zest
5 mL of orange liquor concentrate

Vodka Tonic with Lime
740 mL of 92% alcohol concentrate
720 mL of water
20 mL of quinine flavor
20 mL of lime extract

Rum and Cola
740 mL of 92% alcohol concentrate
680 mL of water
80 mL of cola flavor

Whiskey and Cola
740 mL of 92% alcohol concentrate
680 mL of water
80 mL of whiskey flavor

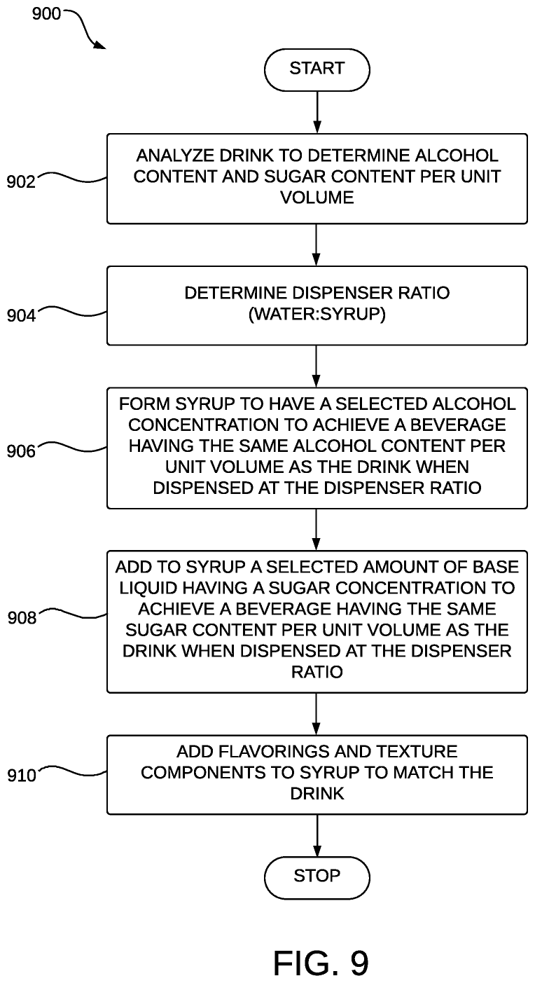

FIG. 9 shows a method 900 for making a syrup to be combined with water to produce a selected alcoholic beverage.

At block 902, a drink to be replicated is analyzed to determine its alcohol and sugar content per unit volume. For example, a six ounce Mimosa cocktail is analyzed to determine its alcohol content and sugar content.

At block 904, a dispenser ratio is determined. For example, the dispenser ratio identifies the ratio of water to syrup that is to be combined to produce the drink. In an embodiment, a typical ratio may be 5:1.

At block 906, a process begins to form the syrup by adding a selected amount of alcohol concentrate so that when the syrup is combined with water at the dispenser ratio, the resulting beverage will have the same alcohol content as the drink that was analyzed. For example, the alcohol concentrate may comprise 92% alcohol that is dispensed with water to produce a beverage having an alcohol content of less than 10%.

At block 908, a selected amount of base liquid (sweetener) having a selected sugar concentration is added to the syrup so that when the syrup is combined with water at the dispenser ratio, the resulting beverage will have the same sugar content as the drink that was analyzed. For example, the sugar concentrate may comprise 10% sugar that will produce a beverage having a sugar content of less than 2%.

At block 910, flavoring and texture components are added to the syrup so that when the syrup is combined with water at the dispenser ratio, the resulting beverage will have the same taste and flavor characteristics as the drink that was analyzed. Once all ingredients are determined, they are mixed or combined to form the syrup which is then pumped into a suitable container, such as a bag-in-box container or a pouch.

Thus, the method 900 operates to form a syrup that can be mixed with water to produce an alcohol cocktail. It should be noted that the operations of the method can be modified, rearranged, added to, deleted, or otherwise changed within the scope of the embodiments.

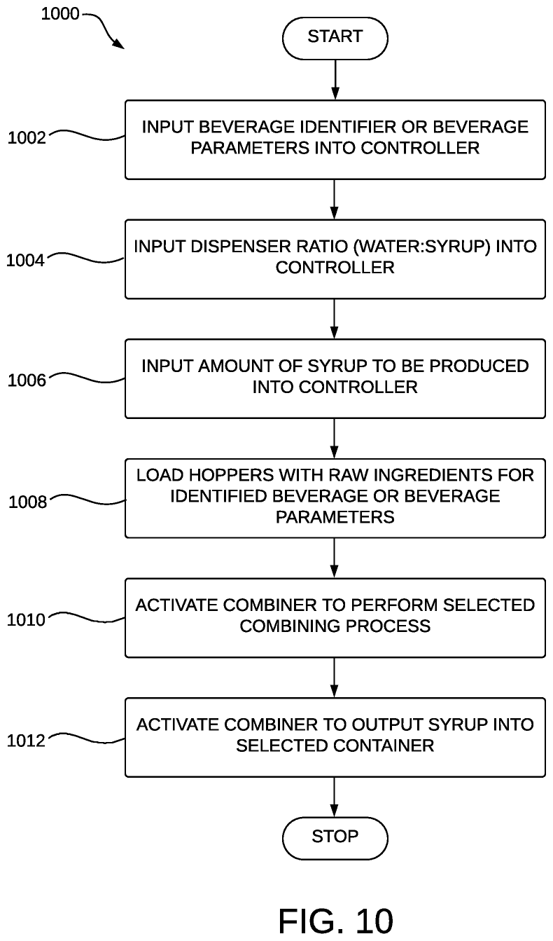

FIG. 10 shows a method 1000 for operating the apparatus of FIG. 8 to generate a syrup.

At block 1002, a beverage identifier or beverage parameters are input to the controller 816. For example, a user can input selections and data to the controller using the input/output line 818. In an embodiment, a user selects a drink from a drink menu. The controller 816 will generate a syrup that can be mixed with water to reproduce the selected drink. In an embodiment, the user can also enter drink parameters directly into the controller, such as alcohol content and sugar content parameters.

At block 1004, a dispenser ratio is entered into the controller. For example, the dispenser ratio identifies the ratio of water to syrup that is to be combined to produce the drink. In an embodiment, a typical ratio may be 5:1. The controller 816 uses the dispenser ratio to determine the amount of each ingredient to be combined into the syrup.

At block 1006, the amount of syrup to be produced is entered into the controller 816. For example, the amount of syrup may be enough to fill one or more bag-in-box containers. For example, an amount such as 9 liters can be entered.

At block 1008, the hoppers of the apparatus shown in FIG. 8 are loaded with raw material. For example, the hopper 802 is filled with alcohol concentrate. In an embodiment, the controller 816 displays to the user the raw materials to be loaded into each hopper in order to make the selected quantity of syrup for the selected drink. For example, given the selected beverage, dispenser ratio, and syrup amount, the controller computes the type and quantities of each ingredient and displays this information to the user. The user then loads an appropriate amount of the ingredients into the designated hoppers.

At block 1010, the combiner 810 is activated to make the selected syrup. For example, a user enters a start command at the controller 816 to activate the combining process. The combiner 810 controls the valves (A-F) to load the ingredients into the combiner that performs any suitable combining process to receive the ingredients from the hoppers and produce the desired syrup in the selected amount.

At block 1012, once the combiner 810 has prepared the syrup, the controller 816 controls the combiner 810 to output the syrup to the selected container 814. For example, the container may be a 1.5 liter bag-in-box container or a plastic pouch.

Thus, the method 1000 operates to control the apparatus in FIG. 8 to form a syrup that can be mixed with water to produce an alcoholic cocktail. It should be noted that the operations of the method can be modified, rearranged, added to, deleted, or otherwise changed within the scope of the embodiments.

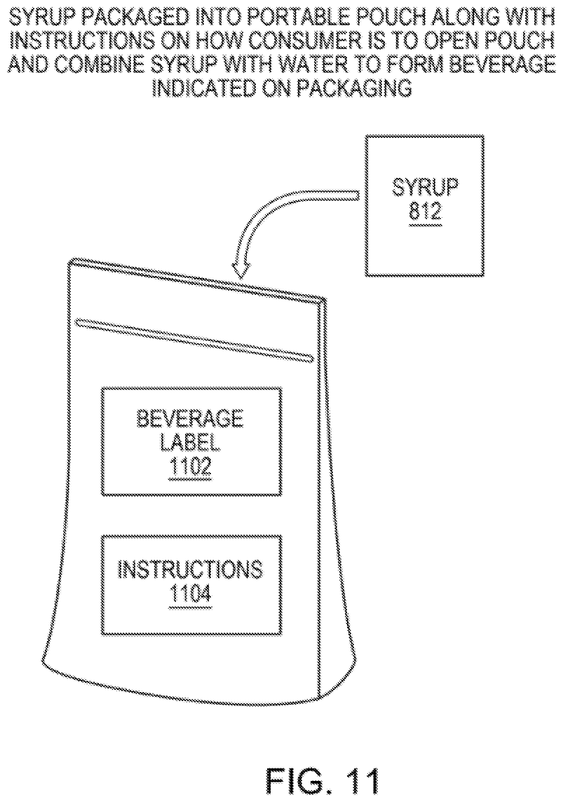

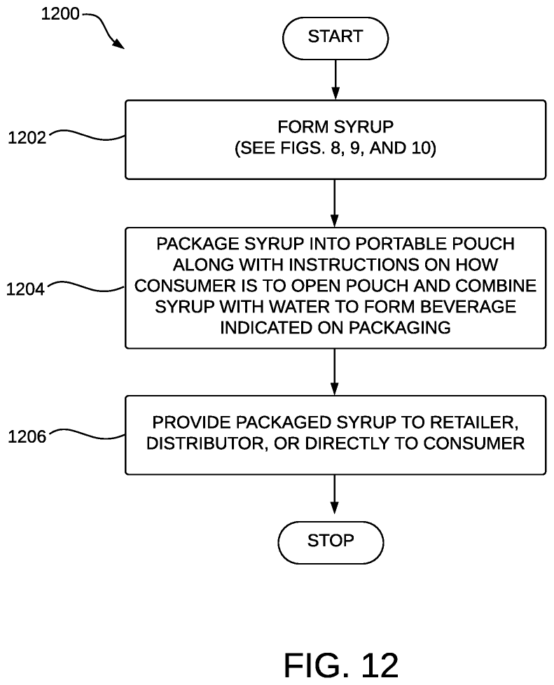

FIG. 11 shows an exemplary pouch that can be used as a package for syrup. The pouch can be used as a package for the syrup 812. The pouch can be in any of a variety of sizes. A label 1102 on the pouch identifies the beverage which can be made from the syrup in the pouch.

Instructions 1104 on the pouch describe how a consumer can mix the syrup in the pouch with water to produce the beverage identified on the label 1102.

FIG. 12 shows a method 1200 for packaging a syrup in a pouch and distributing the pouch to retailers and consumers.

At block 1202, a syrup for a particular alcoholic beverage is produced. For example, a syrup for a Mimosa beverage is produced in accordance with the embodiments shown in FIGS. 8, 9, and 10.

At block 1204, the syrup is packaged in a pouch. For example, the syrup is packaged in the pouch shown in FIG. 11. The pouch includes a label that identifies the beverage that can be made from the syrup. The pouch also includes instructions describing how a consumer can open the pouch and combine the syrup with water to form the beverage.

At block 1206, the pouch containing the syrup is provided to at least one of a retailer, distributor, and directly to a consumer. For example, the pouch can be distributed to retailers for sale and can also be sold directly to consumers.

Thus, the method 1200 operates to package a syrup in a pouch and distribute the pouch to retailers and consumers. It should be noted that the operations of the method can be modified, rearranged, added to, deleted, or otherwise changed within the scope of the embodiments.

Advantageously, the embodiments provide a highly drinkable and stable beverage composition, an improved packaging protocol, and a beverage that has extended shelf life and avoids deterioration due to long or rigorous storage.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the embodiments as set forth in the claims.

1. A system comprising:
a dispenser having first and second input ports, wherein the dispenser is configured to receive a first liquid at the first input port and a second liquid at the second input port, and wherein the dispenser is configured to dispense the first and second liquid in a fixed ratio to form a beverage;
a water source that provides water to the dispenser as the first liquid; and
a syrup source that provides syrup to the dispenser as the second liquid, wherein the syrup comprises a selected concentration of alcohol that is configured to result in the beverage having a selected alcohol content.

2. The system of claim 1, wherein the fixed ratio is a ratio between an amount of the first liquid dispensed to an amount of the second liquid dispensed, and wherein the fixed ratio is selected to be within a range of 2:1 to 30:1.

3. The system of claim 1, wherein the beverage has a selected alcohol content within a range of 1% to 40%.

4. The system of claim 1, wherein the syrup comprises a selected concentration of sugar that is configured to result in the beverage having a selected sugar content.

5. The system of claim 1, wherein the selected alcohol content and the selected sugar content are selected so that the beverage tastes like a selected alcoholic cocktail.

6. The system of claim 1, wherein the syrup comprises additives to enhance flavor and texture of the beverage.

7. The system of claim 1, wherein the dispenser dispenses the beverage in response to an activation signal.

8. The system of claim 7, wherein the dispenser comprises a soda gun that dispenses the beverage, and wherein the activation signal is generated in response to a user pressing a button on the soda gun.

9. The system of claim 7, wherein the dispenser comprises a soda machine that dispenses the beverage, and wherein the activation signal is generated in response to a user pressing a lever on the soda machine.

10. The system of claim 1, wherein the water comprises one of tap water, spring water, filtered water, and carbonated water.

11. The system of claim 1, wherein the syrup is provided in one of a bag-in-box container and a plastic pouch.

12. A method for forming an alcohol-based syrup, which when combined with water in a selected ratio, forms a beverage that replicates a selected alcoholic drink, the method comprising:
determining a drink alcohol content and a drink sugar content of the selected alcoholic drink;
determining the selected ratio that identifies an amount of the water to be combined with an amount of the syrup to form the beverage;
forming the syrup to have an alcohol concentration so that when the syrup is combined with the water in the selected ratio to form the beverage, the beverage will have a beverage alcohol content that matches the drink alcohol content; and
forming the syrup to have a sugar concentration so that when the syrup is combined with the water in the selected ratio to form the beverage, the beverage will have a beverage sugar content that matches the drink sugar content.

13. The method of claim 12, further comprising adding additives to the syrup to further match flavor and texture of the beverage to the selected alcoholic drink.

14. The method of claim 12, wherein the water comprises one of tap water, spring water, filtered water, and carbonated water.

15. The method of claim 12, further comprising packaging the syrup in one of a bag-in-box container and a plastic pouch.

16. The method of claim 12, wherein the selected ratio is selected to be within a range of 2:1 to 30:1.

17. The method of claim 12, wherein the beverage alcohol content is within a range of 1% to 40%.

18. An alcohol-based syrup, comprising:
a syrup; and
a selected amount of alcohol within the syrup to produce a selected alcohol concentration so that when the syrup is combined with the water in a selected ratio to form a beverage, the beverage will have a beverage alcohol content that matches an alcohol content of a selected alcoholic cocktail.

19. The syrup of claim 18, further comprising a selected amount of sugar added to the syrup to produce a sugar concentration so that when the syrup is combined with the water in the selected ratio to form the beverage, the beverage will have a beverage sugar content that matches a sugar content of the selected alcoholic cocktail.

20-23. (canceled)
